(19) United States
(12) Patent Application Publication
(10) Pub. No.: US 2010/0298107 A1
(43) Pub. Date: Nov. 25, 2010

(54) NYLON CONVEYANCE ROLLER

(75) Inventor: CHING FONG HON, Hong Kong (HK)

Correspondence Address: Ben Kwong, Rm404, 4/F., General Commercial Building,, 162 Des Voeux Road, Central, Hong Kong, HK

(73) Assignee: EASYROLL TECHNOLOGY (HK) LIMITED, Hong Kong (HK)

(21) Appl. No.: 12/490,375

(22) Filed: Jun. 24, 2009

(30) Foreign Application Priority Data
May 19, 2009 (CN) 200920154681.1

(51) Int. Cl. A01B 29/00

(52) U.S. Cl. 492/28

(57) ABSTRACT

The present utility model is a nylon conveyance roller used for the lifting platform loader of aircraft cargo transit wagon, wherein there is a tunnel going through the said roller for placing the axle. The tip and toe of the said roller are provided with plane structure, and the outer surface of the said roller is frosted texture. The material Nylon, designed for making the said conveyance roller, is suitable. It can increase the friction between the roller and the floor of container and container plate during cargo conveyance, making skidding conditions or noise during rotating friction unlikely. By using nylon as material, the said roller can boast good wear resistance, low noise, a slim likelihood of skidding condition, and environmental compliance.

### FIELD OF THE TECHNOLOGY

The present utility model relates to the field of technology for aircraft cargo transportation equipment, especially to the conveyance roller of platform loader device for container and container plate lifting platform table, and more specifically, to a nylon conveyance roller.

### BACKGROUND OF THE TECHNOLOGY

As is known to all, the lifting tables for the existing aircraft transportation equipment are all configured with rollers. In many patents, for instance: Chinese patents with Application Number being 200710115257.1, 200410075778.5, 200510042307.9, 200510042357.7 and 200420097138.X, as well as U.S. patents with U.S. Pat. No. 6,409,010, 6,340,083, 6,315,109, 4,981,209 and 6,360,865, a roller device is provided, wherein each roller device involves the roller which pushes the container, container plate to make forward-backward, right-left movement and rotation through the transmission of the roller axle. However, the abovementioned patents do not define the structure, materials of the roller. As a matter of fact, in the aforesaid existing technology, the materials selected for the roller are not properly designed because of the high metal mutual solubility and proneness to adhesion, thus leading to wear. Therefore, aluminum alloy and the wear of aluminum alloy are two different mechanisms along with diversified load; namely, slight wear or oxidative wear takes place under low load, characterized with a layer of compact oxide film on surface due to oxidation with the thickness around 2 μm. Under the action of friction, this layer of oxide film breaks up and peels off, and generates some fine flaky debris. Skidding condition may occur potentially, especially on rainy days, and the object required for conveyance may get out of control. It is required to push the object and convert it to the correct direction manually. Many such cases arise each year of workers getting injured are due to skidding caused by pushing the object. The over high noise generated during the friction of the roller and container, container plate conveyance leads to harm to the ears. Moreover, the roller in the existing technology is made of aluminum or other metal, easy to abrade the floor of container and container plate.

### SUMMARY OF THE UTILITY MODEL

The present utility model provides a conveyance roller made of nylon which is capable of reducing the peeling off of metal and powder during the rotation of metal, and more specifically, preventing skidding on rainy days, relieving workers from manually pushing the object and converting it to the correct direction so as to avoid workers' injury due to skidding during pushing, and as well lowering the noise generated in driving friction.

To realize the abovementioned purposes, the present utility model provides the following technical solution:

A nylon conveyance roller, used for the lifting platform loader of aircraft cargo transit wagon, characterized in that there is a tunnel going through the said roller for placing the axle.

Wherein: the tip and toe of the said roller are provided with plane structure.

Wherein: the outer surface of the said roller is frosted texture.

As shown by the aforesaid technical solution, the nylon conveyance roller provided by the present utility model has the following advantages: suitable material selection, especially the discretionary control in any environmental and weather conditions during transportation, increased friction between the roller and the floor of the container and container plate, slim likelihood of skidding condition and noise generated in driving friction. By using nylon as material, the said roller can boast good wear resistance, low noise, slim likelihood of skidding condition, and environmental compliance.

### DESCRIPTION OF THE DRAWINGS

FIG. 1 is the schematic view of the structure of the nylon conveyance roller provided by the present utility model.

### DETAILED DESCRIPTION OF THE EMBODIMENTS

For a better understanding of the technical solution, the present utility model is further detailed hereinafter in combination with the drawings.

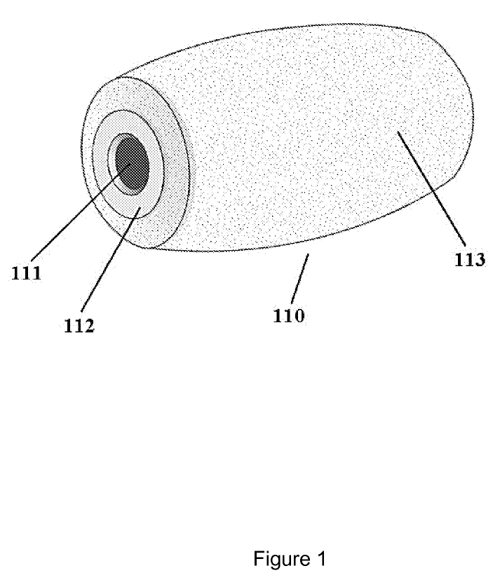

The nylon conveyance roller for the present utility model is used for the lifting platform loader of aircraft cargo transit wagon. The protection level for ground operation at the airport is high, but the application of the roller made of aluminum or metal materials may lead to serious abrasion to the roller, high noise and the likelihood of skidding condition. As shown in FIG. 1, a nylon conveyance roller, wherein there is a tunnel 111 going through the said roller 110, the rotation axle of the roller can be placed into tunnel 111 and fixed on the axle bracket of the roller via the said rotation axle of the roller, thus for conveyance use. The tip and toe 112 of the said roller 110 are provided with plane structure so as to fit other tracks. The outer surface 113 of the said roller 110 is frosted texture, in this way to increase the friction between the roller and the floor of the container and container plate. The said nylon conveyance roller 110 is made of nylon, so it is durable and abrasion resistant in use, and prevents skidding. The said nylon material is composed of polyamide (PA), Polytetrafluoroethene (PTFE) and glass fiber (GF). These materials, basic for making the roller, can improve the wear coefficient of the materials, abrasion resistance and prevent skidding. Other additives can be further added to increase wear resistance and oxidation prevention, such as compatilizer agent, silicate compound, organic silicate, anti-oxidant agent and inorganic pan tone. These additives are used for: improving the associability between PA and PTFE, enhancing material elasticity and wear resistance, prolonging the service life of materials and coloring respectively.

Wherein: the tip and toe 112 of the said nylon roller are provided with plane structure so as to fit other tracks.

Wherein: the outer surface 113 of the said nylon roller is frosted texture, to increase the friction and prevent skidding.

The nylon conveyance roller provided by the present utility model boasts suitable material designed and increased friction between the roller and the floor of container and container plate during conveyance, thus leading to a slim likelihood of skidding condition and noise generated in driving friction. By using nylon as the material, the said roller realizes good wear resistance, low noise, slim likelihood of skidding condition, as well as environmental compliance.

The said nylon roller 100 is fabricated by means of injection molding and lathe machining tunnel. It can be applied in the roller device provided by Chinese patents with Application Number being 200710115257.1, 200410075778.5, 200510042307.9, 200510042357.7 and 200420097138.X, as well as U.S. patents with Patent Number being U.S. Pat. No. 6,409,010, 6,340,083, 6,315,109, 4,981,209 and 6,360,865, and so on. The roller has good durability, strong toughness and rigidity, and the capability of withstanding high impact. In addition to the skidding preventive function of the material, the frosted texture appearance can further guarantee slip resistance. Furthermore, the roller can avoid the peeling off of metal and powder during the rotation of metal which may contaminate the environment, the entry into eyes and respiratory tract to harm the human body, reducing the jarring and vibrating noise generated in friction of metal and metal transmission, thus decreasing harm to the ears. More importantly, it can offer excellent performance at a reasonable cost.

The nylon conveyance roller provided by the embodiment of the present utility model is illustrated in detail hereinbefore. It may be altered by those generally skilled in the art according to the spirit of the embodiment for the present utility model on specific implementation mode and application scope. To sum up, the contents of the Specification are not intended to limit the present utility model as understood.

1. A nylon conveyance roller used for the lifting platform loader of an aircraft cargo transit wagon, characterized in that the nylon conveyance roller has a tunnel for placing the axle.

2. The said nylon conveyance roller as claimed in claim 1, characterized in that the tip and toe of the said roller are provided with plane structure.

3. The said nylon conveyance roller as claimed in claim 1, characterized in that the outer surface of the nylon conveyance roller is frosted texture.
